(19) United States
(12) Patent Application Publication
(10) Pub. No.: US 2016/0291722 A1
(43) Pub. Date: Oct. 6, 2016

(54) Array Substrate, Display Panel and Display Device

(71) Applicants: Shanghai Tianma Micro-Electronics Co., Ltd., Shanghai (CN); Tianma Micro-Electronics Co., Ltd., Shenzhen (CN)

(72) Inventors: Lingxiao Du, Shanghai (CN); Qijun Yao, Shanghai (CN)

(21) Appl. No.: 14/813,067

(22) Filed: Jul. 29, 2015

(30) Foreign Application Priority Data
Apr. 1, 2015 (CN) 201510153209.6

(51) Int. Cl. G06F 3/044

(52) U.S. Cl. CPC G06F 3/044

(57) ABSTRACT

An array substrate, a display panel, and a display device are disclosed. The array substrate includes: multiple gate lines, multiple data lines and multiple touch lines. The multiple data lines and multiple touch lines are insulated from each other, and extend in parallel directions. Each of the touch lines includes multiple line conductive portions and multiple connectors. The line conductive portions are located in the same layer with the gate lines and each of the line conductive portions is located between two adjacent gate lines. The connectors are located in a different conductive layer from the line conductive portions and the connectors connect two adjacent line conductive portions through a via hole. The coupling capacitance between the line conductive portions and the touch electrode positionally corresponding thereto may be reduced, to ensure a high accuracy of a touch operation for the display device.

### CROSS REFERENCE TO RELATED APPLICATIONS

The present application claims the priority of Chinese Patent Application No. 201510153209.6, titled “ARRAY SUBSTRATE, DISPLAY PANEL AND DISPLAY DEVICE”, filed on Apr. 1, 2015 with the State Intellectual Property Office of People's Republic of China, which is incorporated herein by reference in its entirety.

### TECHNICAL FIELD

The disclosure relates to the field of touch display technologies, and in particular to an array substrate, a display panel and a display device.

### BACKGROUND

In the initial stages of development of touch display technologies, a touch display panel is formed by combining a touch panel and a display panel, to achieve a touch display function. The touch panel and the display panel are needed to be prepared separately, thereby resulting in high cost, a large thickness and low productivity.

With the development of self-capacitive touch display integrated technology, a common electrode of the array substrate in the display panel may double as a touch sensing electrode for self-capacitive touch detection, and a touch control operation and a display control operation are performed in a time-division manner by driving the common electrode in a time-division manner, thus the touch function and the display function may be achieved synchronously. In this way, the touch sensing electrode is integrated within the panel, thereby reducing the fabrication cost, improving the productivity and greatly reducing the thickness of the panel.

In the case that the common electrode doubles as the touch sensing electrode, the common electrode layer is needed to be divided into multiple separate touch electrodes. In order to control a touch operation and a display operation in a time-division manner, a touch sensing signal is needed to be provided for a respective touch electrode via a touch line in a touch period of time, and a display driving voltage signal is needed to be provided for a respective touch electrode via the touch line in a display period of time. However, the existing self-capacitive touch display device has a low accuracy of a touch operation.

### SUMMARY

In view of the above, an array substrate, a display panel and a display device are provided according to the disclosure, and line conductive portions of a touch line are located in the same layer with gate lines, to reduce the coupling capacitance between the touch line and touch electrodes which the touch line passes by, thereby improving an accuracy of a touch operation for the display device.

To achieve the above objects, the technical solutions as follows are provided according to the disclosure.

An array substrate is provided, which includes: multiple gate lines, multiple data lines and multiple touch lines insulated from each other, where extending directions of the touch lines are parallel to those of the data lines, each of the touch lines includes multiple line conductive portions and multiple connectors, the line conductive portions are located in the same layer with the gate lines and each of the line conductive portions is located between two adjacent gate lines, the connectors are located in a different conductive layer from the line conductive portions and the connector connects two adjacent line conductive portions through a via hole.

Furthermore, a display panel is further provided according to the disclosure, which includes the above array substrate.

Additionally, a display device is further provided according to the disclosure, which includes the above display panel.

Compared with the conventional technology, the technical solutions according to the disclosure have at least the following advantages:

the array substrate, the display panel and the display device are provided in the present disclosure, and the array substrate includes: multiple gate lines, multiple data lines and multiple touch lines insulated from each other; extending directions of the touch lines are parallel to those of the data lines, each of the touch lines includes multiple line conductive portions and multiple connectors, the line conductive portions are located in the same layer with the gate lines and each of the line conductive portions is located between two adjacent gate lines, the connectors are located in a different conductive layer from the line conductive portions and the connector connects two adjacent line conductive portions through a via hole.

It can be seen from the above description that, in the technical solutions according to the disclosure, the touch lines are implemented as wirings including multiple line conductive portions and multiple connectors, the line conductive portions of the touch lines are located in the same layer with the gate lines, and two adjacent line conductive portions are electrically connected through the via hole. Therefore, the distance between the conductive layer where the line conductive portions are located and the conductive layer where the touch electrodes are located may be increased, and the coupling capacitance between the line conductive portions and the touch electrodes positionally corresponding thereto may be reduced, to ensure a high accuracy of a touch operation for the display device.

### BRIEF DESCRIPTION OF THE DRAWINGS

To describe the technical solutions for the embodiments of the present disclosure more clearly, the following briefly describes the drawings involved in the embodiments of the present disclosure. Apparently, the drawings described below are some embodiments, and persons of ordinary skill in the art can derive other drawings according to the drawings without any creative effort.

FIG. 1 is a schematic structural diagram of an existing array substrate;

FIG. 2 is a schematic structural diagram of an array substrate according to an embodiment of the disclosure;

FIG. 3a is a section view taken along aa′ in FIG. 2 according to an embodiment of the disclosure;

FIG. 3b is a section view taken along aa′ in FIG. 2 according to an embodiment of the disclosure;

FIG. 3c is a section view taken along aa′ in FIG. 2 according to an embodiment of the disclosure;

FIG. 4a is a section view taken along aa′ in FIG. 2 according to an embodiment of the disclosure;

FIG. 4b is a section view taken along aa′ in FIG. 2 according to an embodiment of the disclosure;

FIG. 4c is a section view taken along aa′ in FIG. 2 according to an embodiment of the disclosure;

FIG. 5a is a section view taken along aa′ in FIG. 2 according to an embodiment of the disclosure;

FIG. 5b is a section view taken along aa′ in FIG. 2 according to an embodiment of the disclosure;

FIG. 5c is a section view taken along aa′ in FIG. 2 according to an embodiment of the disclosure;

FIG. 5d is a section view taken along aa′ in FIG. 2 according to an embodiment of the disclosure

### DETAILED DESCRIPTION OF EMBODIMENTS

The technical solutions of embodiments of the disclosure will be illustrated clearly and completely in conjunction with the drawings of the embodiments of the disclosure. Apparently, the described embodiments are only a few embodiments rather than all embodiments of the disclosure. Any other embodiments obtained by those skilled in the art on the basis of the embodiments of the present disclosure without creative work will fall within the scope of the present disclosure.

As described in BACKGROUND, the existing self-capacitive touch display device has a low accuracy of a touch operation. The inventor has found that, this issue is caused mainly by the fact that the distance between the conductive layer where line conductive portions are located and the conductive layer where touch electrodes are located is short, and the coupling capacitance between the touch line and the touch electrodes which the touch line passes by is large, thereby resulting in a low accuracy of a touch operation for the display device.

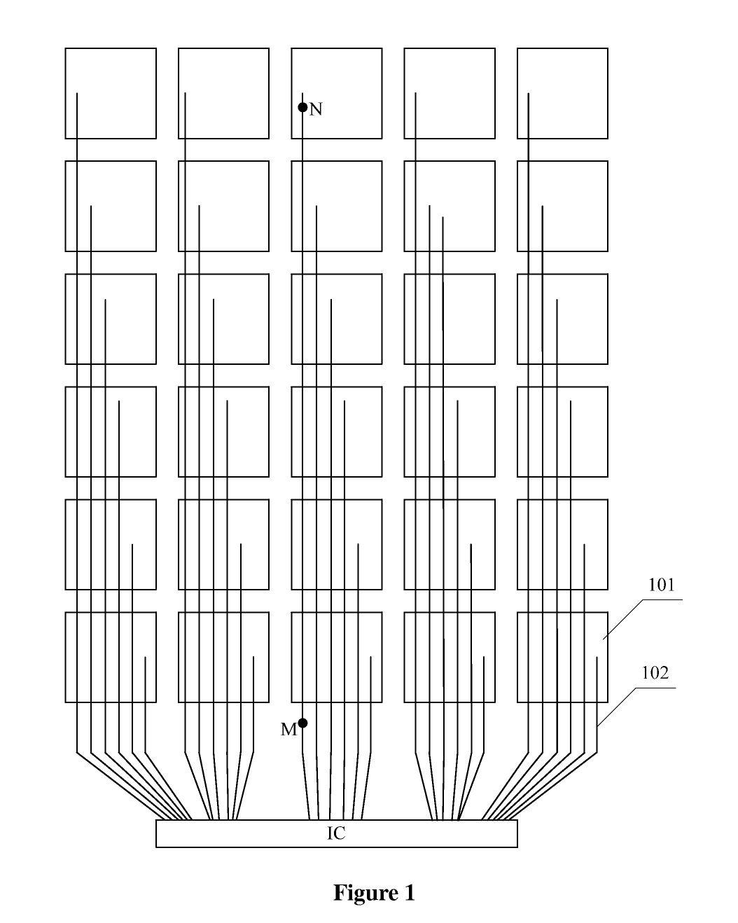

FIG. 1 shows a schematic structural diagram of an array substrate. The common electrode layer of the array substrate is divided into multiple separate touch electrodes 101. Each of the touch electrodes 101 is connected to a driving circuit IC via a respective touch line 102. The driving circuit IC outputs and transmits a touch sensing signal to a respective touch electrode 101 via the touch line 102. In the case that the touch sensing signal is transmitted from point M to point N, the touch line 102 between point M and point N passes by multiple touch electrodes 101, and the distance between the touch line 102 and the touch electrodes 101 is small, thereby causing a large coupling capacitance between the touch line 102 and the touch electrodes 101 which the touch line 102 passes by. Therefore, interference occurs in the case that the touch sensing signal is transmitted from point M to point N, which causes that the touch sensing signal transmitted in a limited time to the touch electrode 101 connected to the touch line 102 can not satisfy the requirements, and thus the display device has a low accuracy of a touch operation.

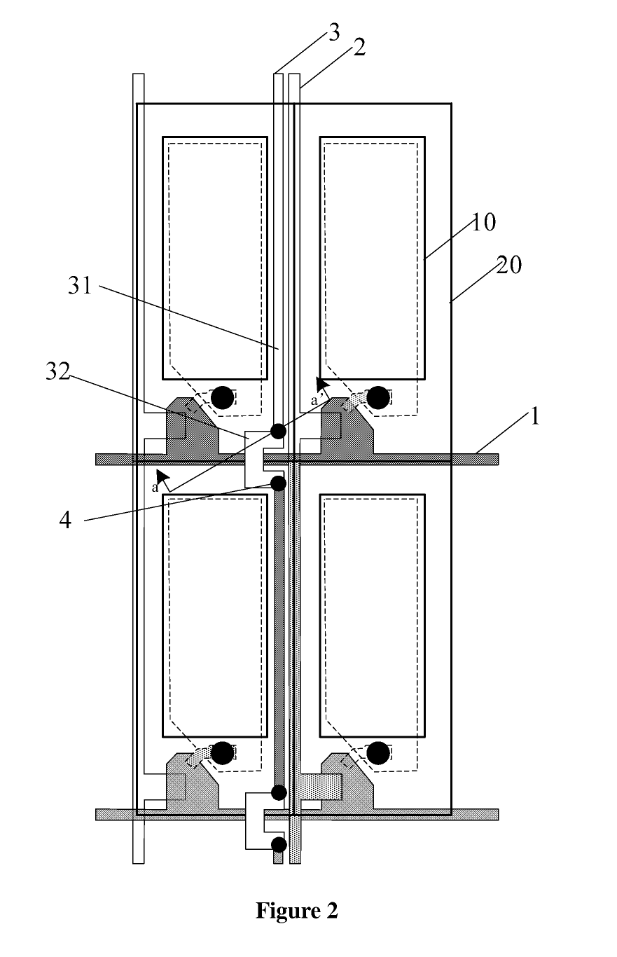

Hence, an array substrate is provided according to the embodiments of the disclosure, and the distance between the touch line and the touch electrodes which the touch line passes by is increased, to reduce the coupling capacitance between the touch line and the touch electrodes which the touch line passes by, thereby improving the accuracy of a touch operation for the display device including the array substrate. The array substrate according to the embodiments of the disclosure is described in details in conjunction with FIG. 2 to FIG. 5d.

FIG. 2 shows a schematic structural diagram of an array substrate according to an embodiment of the disclosure. It should be noted that FIG. 2 only shows a structure of a part of the display region of the array substrate. The array substrate includes: multiple gate lines 1, multiple data lines 2 and multiple touch lines 3 insulated from each other.

Extending directions of the touch lines 3 are parallel to those of the data lines 2. Touch lines 3 and data lines 2 may extend in a vertical direction, as shown in FIG. 2. Each of the touch lines 3 may include multiple line conductive portions 31 and multiple connectors 32. The line conductive portions 31 are located in the same layer with the gate lines 1, and each of the line conductive portions 31 is located between two adjacent gate lines 1. The connectors 32 are located in a different conductive layer from the line conductive portions 31, and the connector 32 connects two adjacent line conductive portions 31 through a via hole.

In the array substrate, the distance between the conductive layer where the gate lines 1 are located and the common electrode layer is large, and the touch line 3 is divided into two portions, namely, multiple line conductive portions 31 and multiple connectors 32. The line conductive portions 31 are located in the same layer with the gate lines 1 and each of the line conductive portions 31 is located between two adjacent gate lines 1, and the connectors connect two adjacent line conductive portions 31 to ensure signal conduction between the two adjacent line conductive portions 31. In the technical solutions according to the embodiments of the disclosure, the distance between the line conductive portions 31 in the touch line 3 and the touch electrodes which the touch line 3 passes by is increased, to reduce the coupling capacitance between the touch line 3 and the touch electrodes which the touch line 3 passes by, thereby improving an accuracy of a touch operation for the display device including the array substrate.

To prevent the touch lines from affecting the light transmission of the display device, the line conductive portions and the connectors in the touch lines are located in respective shielded regions of sub pixels positionally corresponding to the touch lines according to the embodiments of the disclosure. In addition, to avoid signal interference between the touch lines and the data lines, the touch lines are not overlapped with the data lines in a light transmitting direction of the array substrate.

In the embodiments of the disclosure, the conductive portions are connected to the connectors through via holes. The extending direction of the touch line is parallel to that of the data line, and the driving circuit is located on one end of the touch line, and thus the touch line is overlapped with the gate line. Therefore, the touch line is needed to be divided into multiple line conductive portions and multiple connectors, the connectors are located in a different layer from the gate lines, and two adjacent line conductive portions are electrically connected via the connector, thereby avoiding a short circuit between the touch line and gate line.

As shown in FIG. 2, the gate lines 1 are insulated from and intersect with the data lines 2 to define multiple sub pixels, and each of the sub pixels includes a transparent area 10 and a shielded region 20 around the transparent area 10. Via holes 4 are formed on the opposite ends of the two adjacent line conductive portions 31, and the two adjacent line conductive portions 31 are electrically connected via one of the connectors 32 through two via holes. Preferably, the line conductive portions and the connectors are located in the shielded region in the embodiment of the disclosure. It should be noted that, components such as a thin film transistor and a pixel electrode are further located in each of the sub pixels according to the embodiments of the disclosure, which are the same as those in the conventional technology and are omitted herein.

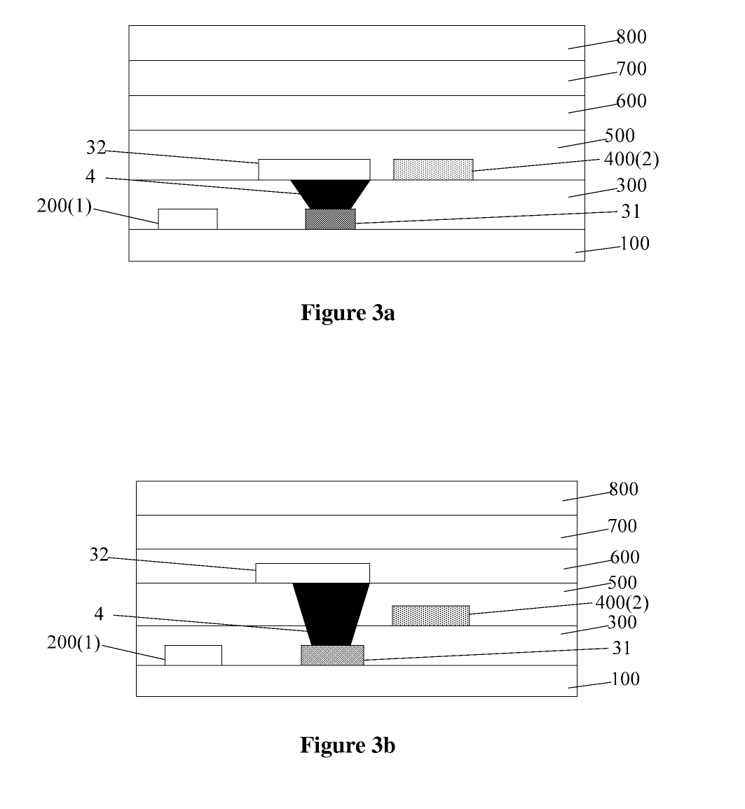

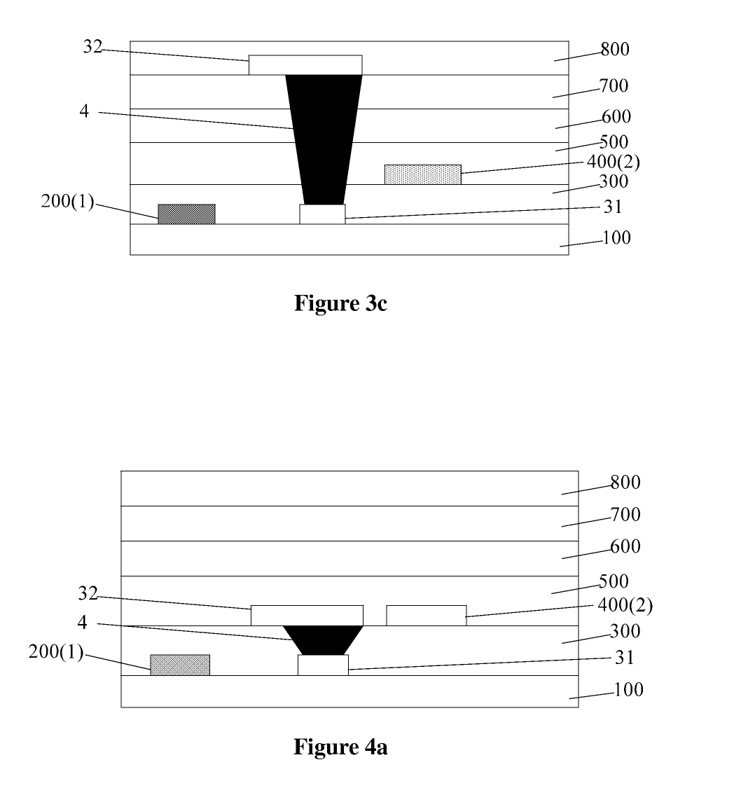

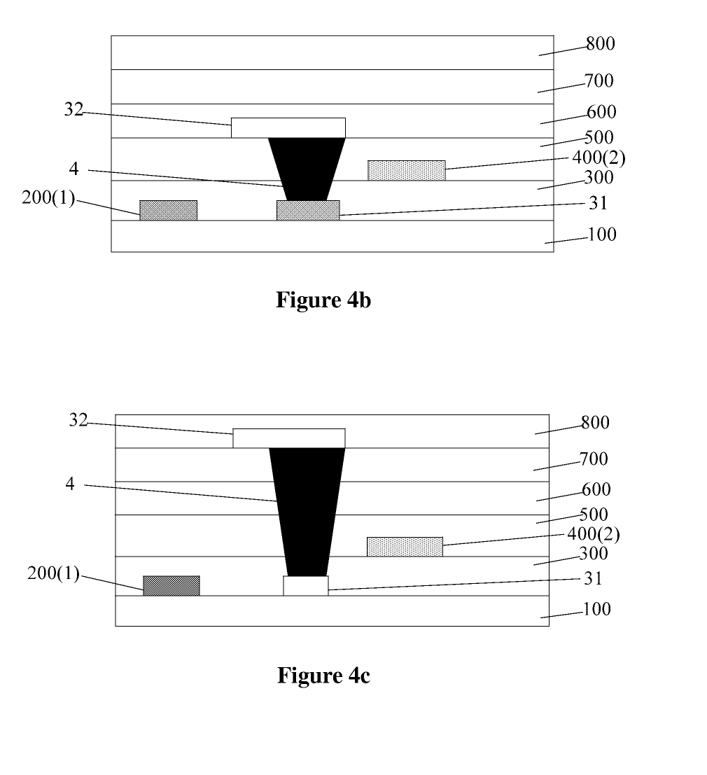

It should be noted that, the conductive layer where the connectors are located is not defined, as long as the connectors are located in a different conductive layer from the gate lines; additionally, the type of the array substrate also is not defined in the embodiment of the disclosure. The array substrate according to the embodiments of the disclosure is described in details in conjunction with FIG. 3a to FIG. 4c.

FIG. 3a shows a section view taken along aa′ in FIG. 2 according to an embodiment of the disclosure. The array substrate includes, in a light transmitting direction of the array substrate:

a substrate 100;

a first conductive layer 200 located on a surface of the substrate 100;

a gate dielectric layer 300 located on a side of the first conductive layer 200 away from the substrate 100;

a second conductive layer 400 located on a side of the gate dielectric layer 300 away from the substrate 100;

a first insulation layer 500 located on a side of the second conductive layer 400 away from the substrate 100; and

a driving electrode layer located on a side of the first insulation layer 500 away from the substrate 100.

The driving electrode layer includes a first electrode layer 600 and a second electrode layer 800 which are located on the side of the first insulation layer 500 away from the substrate 100, and a second insulation layer 700 located between the first electrode layer 600 and the second electrode layer 800.

The array substrate according to the embodiment of the disclosure may be a bottom-gate array substrate.

That is, the gate lines 1 are located in the first conductive layer 200, the data lines 2 are located in the second conductive layer 400, and the line conductive portions 31 of the touch line 3 are also located in the first conductive layer 200.

In the bottom-gate array substrate according to the embodiment of the disclosure, multiple gates are located in the first conductive layer 200, and multiple sources and multiple drains are located in the second conductive layer 400. It should be noted that, a semiconductor layer is located between the gate dielectric layer 300 and the second conductive layer 400, and multiple active regions are located in the semiconductor layer, in the array substrate according to the embodiment of the disclosure. A thin film transistor in the array substrate is constituted of the respective gate, source, drain and active region.

As shown in FIG. 3a, the line conductive portions 31 are located in the same layer with the gate lines 1, the connectors 32 according to the embodiment of the disclosure may be located in the same layer with the data lines 2, and via holes 4 may be located in the gate dielectric layer 300 to allow the connectors 32 to connect the line conductive portions 31 through the via holes 4.

FIG. 3b shows a section view taken along aa′ in FIG. 2 according to another embodiment of the disclosure, the line conductive portions 31 are located in the same layer with the gate lines 1, the connectors 32 according to the embodiment of the disclosure may alternatively be located in the first electrode layer 600, and via holes 4 may be located in the gate dielectric layer 300 and the first insulation layer 500 to allow the connectors 32 to connect the line conductive portions 31 through the via holes 4.

FIG. 3c shows a section view taken along aa′ in FIG. 2 according to still another embodiment of the disclosure, the line conductive portions 31 are located in the same layer with the gate lines 1, the connectors 32 according to the embodiment of the disclosure may alternatively be located in the second electrode layer 800, and via holes 4 may be located in the gate dielectric layer 300, the first insulation layer 500 and the second insulation layer 700 to allow the connectors 32 to connect the line conductive portions 31 through the via holes 4.

Additionally, the array substrate according to the embodiment of the disclosure may be a top-gate array substrate. FIG. 4a shows a section view taken along aa′ in FIG. 2 according to still another embodiment of the disclosure. The array substrate includes, in a light transmitting direction of the array substrate:

a substrate 100;

a first conductive layer 200 located on a surface of the substrate 100;

a gate dielectric layer 300 located on a side of the first conductive layer 200 away from the substrate 100;

a second conductive layer 400 located on a side of the gate dielectric layer 300 away from the substrate 100;

a first insulation layer 500 located on a side of the second conductive layer 400 away from the substrate 100; and

a driving electrode layer located on a side of the first insulation layer 500 away from the substrate 100. The driving electrode layer includes a first electrode layer 600 and a second electrode layer 800 which are located on the side of the first insulation layer 500 away from the substrate 100, and a second insulation layer 700 located between the first electrode layer 600 and the second electrode layer 800.

The array substrate according to the embodiment of the disclosure is the top-gate array substrate.

That is, the gate lines 1 are located in the first conductive layer 200, the data lines 2 are located in the second conductive layer 400, and the line conductive portions 31 of the touch line 3 are also located in the first conductive layer 200.

In the top-gate array substrate according to the embodiment of the disclosure, multiple gates are located in the first conductive layer 200, and multiple sources and multiple drains are located in the second conductive layer 400. It should be noted that, a semiconductor layer is located between the substrate 100 and the first conductive layer 200, a gate insulation layer is located between the semiconductor layer and the first conductive layer 200, and multiple active regions are located in the semiconductor layer, in the array substrate according to the embodiment of the disclosure; a thin film transistor in the array substrate is constituted of the respective gate, source, drain and active region. Additionally, a light filtering layer is needed to be located between the active region and the substrate in the case that the thin film transistor in the array substrate is a top-gate thin film transistor.

As shown in FIG. 4a, the line conductive portions 31 are located in the same layer with the gate lines 1, the connectors 32 according to the embodiment of the disclosure may be located in the same layer with the data lines 2, and via holes 4 may be located in the gate dielectric layer 300 to allow the connectors 32 to connect the line conductive portions 31 through the via holes 4.

FIG. 4b shows a section view taken along aa′ in FIG. 2 according to still another embodiment of the disclosure, the line conductive portions 31 are located in the same layer with the gate lines 1, the connectors 32 according to the embodiment of the disclosure may alternatively be located in the first electrode layer 600, and via holes 4 may be located in the gate dielectric layer 300 and the first insulation layer 500 to allow the connectors 32 to connect the line conductive portions 31 through the via holes 4.

FIG. 4c shows a section view taken along aa′ in FIG. 2 according to still another embodiment of the disclosure, the line conductive portions 31 are located in the same layer with the gate lines 1, the connectors 32 according to the embodiment of the disclosure may alternatively be located in the second electrode layer 800, and via holes 4 may be located in the gate dielectric layer 300, the first insulation layer 500 and the second insulation layer 700 to allow the connectors 32 to connect the line conductive portions 31 through the via holes 4.

It should be noted that, locations of the pixel electrode layer and the common electrode layer may not be defined in the array substrate according to the embodiments of the disclosure. The first electrode layer may be the pixel electrode layer and the second electrode layer may be the common electrode layer; or the first electrode layer may be the common electrode layer and the second electrode layer may be the pixel electrode layer. Additionally, in another embodiment of the disclosure, since the pixel electrode layer is not overlapped with the data lines in the case that the first electrode layer is the pixel electrode layer, the first electrode layer may be located in the same layer with the second conductive layer. In this case, the array substrate includes, in a light transmitting direction of the array substrate:

a substrate;

a first conductive layer located on a surface of the substrate;

a gate dielectric layer located on a side of the first conductive layer away from the substrate;

a second conductive layer located on a side of the gate dielectric layer away from the substrate;

a first electrode layer located in the same layer with the second conductive layer;

a third insulation layer located on a side of the second conductive layer away from the substrate; and

a second electrode layer located on a side of the third insulation layer away from the substrate, where the first electrode layer is a pixel electrode layer and the second electrode layer is a common electrode layer.

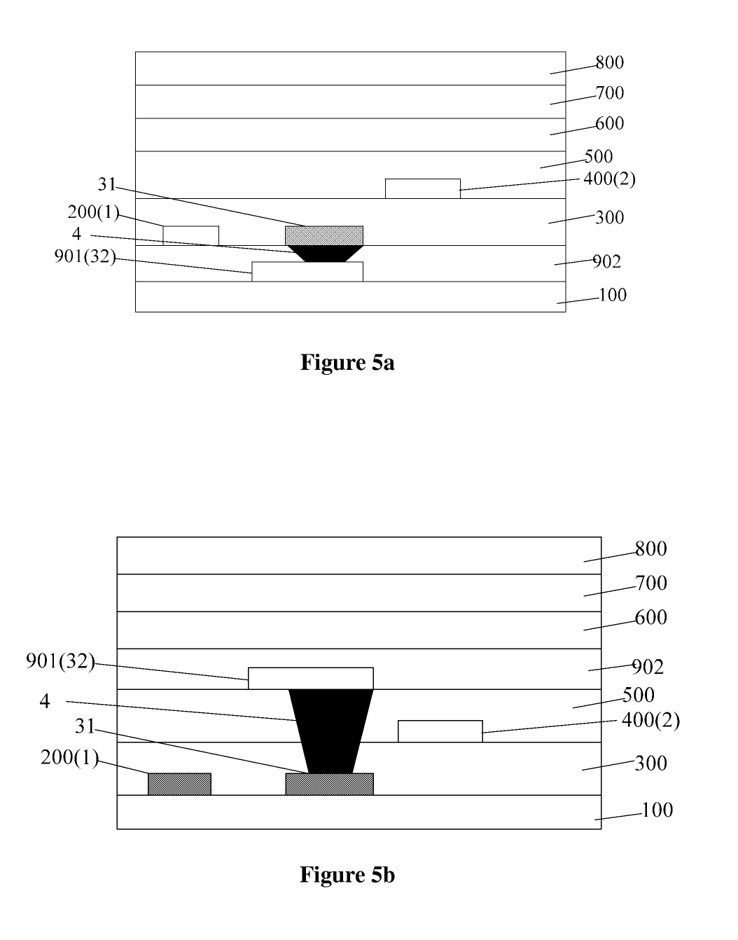

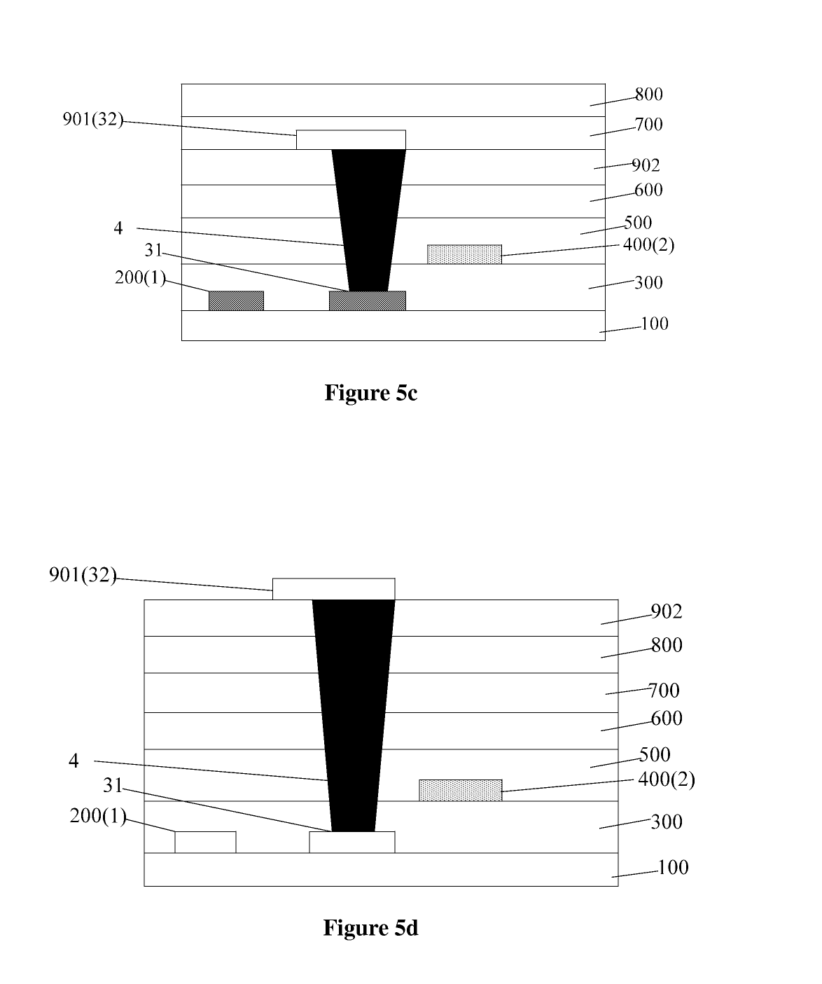

It can be seen from the above description that, the connectors according to the embodiments of the disclosure may be located in the original conductive layers in the array substrate, such as the conductive layer where the data lines are located, the common electrode layer or the pixel electrode layer, to avoid complication of the fabrication process caused by adding a film layer; furthermore, in the case that the connectors are located in the same layer with the conductive layer where the data lines are located, the common electrode layer or the pixel electrode layer, the connectors may be made of different material from that of the same layer. Additionally, the connectors according to the embodiment of the disclosure may also be located in a separate film layer. The array substrate as shown in FIG. 3 is taken as an example for illustration in conjunction with FIGS. 5a to 5d.

FIG. 5a shows a section view taken along aa′ in FIG. 2 according to still another embodiment of the disclosure. The array substrate includes, in a light transmitting direction of the array substrate:

a substrate 100;

a first conductive layer 200 located on a surface of the substrate 100;

a gate dielectric layer 300 located on a side of the first conductive layer 200 away from the substrate 100;

a second conductive layer 400 located on a side of the gate dielectric layer 300 away from the substrate 100;

a first insulation layer 500 located on a side of the second conductive layer 400 away from the substrate 100; and

a driving electrode layer located on a side of the first insulation layer 500 away from the substrate 100. The driving electrode layer includes a first electrode layer 600 and a second electrode layer 800 which are located on the side of the first insulation layer 500 away from the substrate 100, and a second insulation layer 700 located between the first electrode layer 600 and the second electrode layer 800.

The array substrate may further include an auxiliary conductive layer 901 and a fourth insulation layer 902. The auxiliary conductive layer 901 is located between the substrate 100 and the first conductive layer 200, and the fourth insulation layer 902 is located between the auxiliary conductive layer 901 and the first conductive layer 200. The connectors 32 may be located in the auxiliary conductive layer 901, and the via holes 4 are located in the fourth insulation layer 902 to allow the connectors 32 to connect the line conductive portions 31 through the via holes 4.

FIG. 5b shows a section view taken along aa′ in FIG. 2 according to still another embodiment of the disclosure. The auxiliary conductive layer 901 is located between the first insulation layer 500 and the first electrode layer 600, and the fourth insulation layer 902 is located between the auxiliary conductive layer 901 and the first electrode layer 600. The connectors 32 may be located in the auxiliary conductive layer 901, and the via holes 4 are located in the gate dielectric layer 300 and the first insulation layer 500, to allow the connectors 32 to connect the line conductive portions 31 through the via holes 4.

FIG. 5c shows a section view taken along aa′ in FIG. 2 according to another embodiment of the disclosure. The auxiliary conductive layer 901 is located between the first electrode layer 600 and the second insulation layer 700, and the fourth insulation layer 902 is located between the first electrode layer 600 and the auxiliary conductive layer 901. The connectors 32 may be located in the auxiliary conductive layer 901, and the via holes 4 are located in the gate dielectric layer 300, the first insulation layer 500 and the fourth insulation layer 902, to allow the connectors 32 to connect the line conductive portions 31 through the via holes 4.

FIG. 5d shows a section view taken along aa′ in FIG. 2 according to still another embodiment of the disclosure. The auxiliary conductive layer 901 is located on a side of the second electrode layer 800 away from the substrate 100, and the fourth insulation layer 902 is located between the second electrode layer 800 and the auxiliary conductive layer 901. The connectors 32 may be located in the auxiliary conductive layer 901, and the via holes 4 are located in the gate dielectric layer 300, the first insulation layer 500, the second insulation layer 700 and the fourth insulation layer 902, to allow the connectors 32 to connect the line conductive portions 31 through the via holes 4.

It should be noted that, some drawings of FIG. 3a to FIG. 5d show that the via holes 4 pass through the first electrode layer and/or the second electrode layer, only for making drawings and illustrating the embodiments conveniently, and the portions of the via holes 4 in the first electrode layer and/or the second electrode layer are not short-connected to the lines in the first electrode layer and/or the second electrode layer.

Furthermore, a display panel is further provided according to an embodiment of the disclosure, which includes the array substrate according to any one of the above embodiments.

Additionally, a display device is further provided according to an embodiment of the disclosure, which includes the above display panel.

The array substrate, the display panel and the display device are provided according to the embodiments of the present disclosure, and the array substrate includes: multiple gate lines, multiple data lines and multiple touch lines insulated from each other; extending directions of the touch lines are parallel to those of the data lines, each of the touch lines includes multiple line conductive portions and multiple connectors, the line conductive portions are located in the same layer with the gate lines and each of the line conductive portions is located between two adjacent gate lines, the connectors are located in a different conductive layer from the line conductive portions and the connector connects two adjacent line conductive portions through a via hole.

It can be seen from the above description that, in the technical solutions according to the embodiments of the disclosure, the touch lines are disposed as wirings including multiple line conductive portions and multiple connectors, the line conductive portions of the touch line are located in the same layer with the gate lines, and two adjacent line conductive portions are electrically connected through the via hole. Therefore, the distance between the conductive layer where the line conductive portions are located and the conductive layer where touch electrodes are located may be increased, and the coupling capacitance between the line conductive portions and the touch electrodes positionally corresponding thereto may be reduced, to ensure a high accuracy of a touch operation for the display device.

The description of the embodiments disclosed herein enables those skilled in the art to implement or use the present disclosure. Numerous modifications to the embodiments are apparent to those skilled in the art, and the general principle herein can be implemented in other embodiments without deviation from the spirit or scope of the present disclosure. Therefore, the present disclosure is not limited to the embodiments described herein, but in accordance with the widest scope consistent with the principle and novel features disclosed herein.

1. An array substrate, comprising:
a plurality of gate lines, a plurality of data lines and a plurality of touch lines insulated from each other;
wherein the touch lines are extended in a first direction and the data lines are extended in a second direction such that the first and second direction are parallel;
wherein each of the touch lines comprises a plurality of line conductive portions and a plurality of connectors, wherein the line conductive portions are located in the same layer as the gate lines;
wherein each of the line conductive portions is located between two adjacent gate lines;
wherein the connectors are located in a different conductive layer from the line conductive portions, and the connector connects two adjacent line conductive portions through a via hole.

2. The array substrate according to claim 1, wherein the array substrate comprises, in a light transmitting direction of the array substrate:
a substrate;
a first conductive layer located on a surface of the substrate;
a gate dielectric layer located on a side of the first conductive layer away from the substrate;
a second conductive layer located on a side of the gate dielectric layer away from the substrate;
a first insulation layer located on a side of the second conductive layer away from the substrate; and
a driving electrode layer located on a side of the first insulation layer away from the substrate, wherein the driving electrode layer comprises a first electrode layer and a second electrode layer which are located on the side of the first insulation layer away from the substrate, and a second insulation layer located between the first electrode layer and the second electrode layer.

3. The array substrate according to claim 2, wherein the first electrode layer is a pixel electrode layer and the second electrode layer is a common electrode layer; or
the first electrode layer is a common electrode layer and the second electrode layer is a pixel electrode layer.

4. The array substrate according to claim 1, wherein the array substrate comprises, in a light transmitting direction of the array substrate:
a substrate;
a first conductive layer located on a surface of the substrate;
a gate dielectric layer located on a side of the first conductive layer away from the substrate;
a second conductive layer located on a side of the gate dielectric layer away from the substrate;
a first electrode layer located in the same layer with the second conductive layer;
a third insulation layer located on a side of the second conductive layer away from the substrate; and
a second electrode layer located on a side of the third insulation layer away from the substrate, wherein the first electrode layer is a pixel electrode layer and the second electrode layer is a common electrode layer.

5. The array substrate according to claim 2, wherein the gate lines are located in the first conductive layer and the data lines are located in the second conductive layer.

6. The array substrate according to claim 5, wherein the line conductive portions are located in the same layer with the gate lines, and wherein the connectors are located in the same layer with the data lines; or
the connectors are located in the first electrode layer; or
the connectors are located in the second electrode layer.

7. The array substrate according to claim 2, further comprising: an auxiliary conductive layer and a fourth insulation layer,
wherein the auxiliary conductive layer is located between the substrate and the first conductive layer and the fourth insulation layer is located between the auxiliary conductive layer and the first conductive layer; or
the auxiliary conductive layer is located between the first insulation layer and the first electrode layer and the fourth insulation layer is located between the auxiliary conductive layer and the first electrode layer; or
the auxiliary conductive layer is located between the first electrode layer and the second insulation layer and the fourth insulation layer is located between the first electrode layer and the auxiliary conductive layer; or
the auxiliary conductive layer is located on a side of the second electrode layer away from the substrate, and the fourth insulation layer is located between the second electrode layer and the auxiliary conductive layer.

8. The array substrate according to claim 7, wherein the connectors are located in the auxiliary conductive layer.

9. A display panel comprising an array substrate, wherein the array substrate comprises
a plurality of gate lines, a plurality of data lines and a plurality of touch lines insulated from each other,
wherein extending directions of the touch lines are parallel to those of the data lines, each of the touch lines comprises a plurality of line conductive portions and a plurality of connectors, the line conductive portions are located in the same layer with the gate lines and each of the line conductive portions is located between two adjacent gate lines, the connectors are located in a different conductive layer from the line conductive portions, and the connector connects two adjacent line conductive portions through a via hole.

10. A display device comprising a display panel, wherein the display panel comprises an array substrate comprising:
a plurality of gate lines, a plurality of data lines and a plurality of touch lines insulated from each other,
wherein extending directions of the touch lines are parallel to those of the data lines, each of the touch lines comprises a plurality of line conductive portions and a plurality of connectors, the line conductive portions are located in the same layer with the gate lines and each of the line conductive portions is located between two adjacent gate lines, the connectors are located in a different conductive layer from the line conductive portions, and the connector connects two adjacent line conductive portions through a via hole.
